(19) United States
(12) Patent Application Publication
(10) Pub. No.: US 2006/0229067 A1
(43) Pub. Date: Oct. 12, 2006

(54) Wireless interface for test and measurement device

(76) Inventors: Dion Heisier, Colorado Springs, CO (US); Michael J. Stevens, Fountain, CO (US); Matthew Gerholdt, Security, CO (US); John Michael Page, Colorado Springs, CO (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/102,035

(22) Filed: Apr. 8, 2005

(51) Int. Cl. H04Q 7/20; H04B 1/38

(52) U.S. Cl. 455/423; 455/424; 455/425; 455/557

(57) ABSTRACT

A network test and measurement system including a data acquisition system that receives frames from a network under test. An analyzer executes software analyzing the output of the data acquisition system. A wireless interface for receiving commands that control the operation of the software.

### BACKGROUND OF THE INVENTION

Monitoring, diagnostics and troubleshooting are critical functions of any network operations. In today's highly competitive telecommunications arena, customer demands for increased network reliability and performance must be balanced against the cost of operating and maintaining the network to support the higher level of desired service. A variety of network and signal test and measurement products are available from a variety of vendors that attempt to maximize the time and resources devoted to planning, troubleshooting, installing, and maintaining modern day packet and signaling networks.

A recent advance in network monitoring is the use of distributed test systems. Such distributed systems generally comprise one or more data acquisition boxes, typically called probes or distributed network analyzers, installed at a customer location that monitor and report on traffic across the network under test to a central controller. The central controller runs analysis software and produces displays and reports based on data received from the data acquisition boxes.

By way of example, the assignee of the present invention manufactures and sells a line distributed network test systems under the moniker AGILENT NETWORK ANALYZER. The Agilent Network Analyzer family of products currently includes the Network Analyzer (NA); the Distributed Network Analyzer (DNA), the Distributed Network Analyzer MX (DNA-MX), and the Distributed Network Analyzer ME (DNA-ME). With the exception of the DNA-ME, which has a fixed Ethernet port, the Agilent DNA's utilize removable Line Interface Modules (LIMs) that provide a wide range of electrical and optical connections suitable for signaling and packet based networks. Physical interfaces include T1, E1, 10/100 Base-T, Gigabit Ethernet, OC-3 and allow analysis of all major LAN/WAN networks including ATM, Ethernet and Frame Relay. These acquisition systems can be daisy-chained together to form a multi-interface, multi-technology test system, where all measurements are automatically synchronized to within 100 ns. Embedded LIM processors dedicated to line rate data acquisition and filtering are designed to handle the unique demands of high-speed data acquisition. The Network Analyzer platform facilitates analyzing data acquisition from the physical layer through the session layer, including statistics and expert analysis. Further information on the Agilent Network Analyzer platform may be found at www.agilent.com.

Distributed network analyzers are headless, meaning they do not have a monitor, keyboard or mouse. In many installations, distributed network analyzers are rack mounted in an equipment closet. Typically, the only display on such units is LED status lights. The central controller which manages the distributed network analyzers generally comprises a remotely located PC. In the case of the above-described Agilent systems the remote PC runs the AGILENT NETWORK TROUBLESHOOTING CENTER (NTC). NTC is a software solution that provides single-user and multi-user access to information collected from one or more Agilent Network Analyzer platforms and other data sources on a network. NTC also provides remote access to one or more Network Analyzer platforms. NTC processes and correlates data into intelligent information, useful for problem isolation and troubleshooting and provides aggregated views of network health and performance, along with the ability to drill down to detailed views of individual LANs, WANs, WLANs, switches, nodes, connections, protocols, and error types. This enables the user to quickly go from identifying a problem from an overall view of a network to isolating the location and nature of the problem. NTC then allows the user to open remote Network Analyzer applications for advanced troubleshooting at the source of the problem.

Users often have a need to access distributed network analyzers locally for configuration and use. One manner to accomplish this is to plug a mobile computer into a network port (such as a LAN or Modem Port associated with the analyzer) and access the distributed network analyzer in the same manner (generally using the same software) as the central controller does, e.g. running NTC. This typically means that the on-site technician must have access to the equipment closest and a nearby network port. In many instances, it is difficult to satisfy both criteria.

The present inventors have recognized a need for new apparatus and methods facilitating use and control of distributed network analyzers.

### BRIEF DESCRIPTION OF THE DRAWINGS

An understanding of certain embodiments of the present invention can be gained from the following detailed description of the invention, taken in conjunction with the accompanying drawings of which:

FIG. 1 is a block diagram of a known distributed network analyzer.

FIG. 2 is a block diagram of a probe in accordance with an embodiment of the present invention.

FIG. 3 is a sample of a web page for use with a probe in accordance with an embodiment of the present invention.

FIG. 4 is a sample screen shot of an interface used for interfacing with a probe in accordance with an embodiment of the present invention.

FIG. 5 is a flow chart of a method in accordance with an embodiment of the present invention.

### DETAILED DESCRIPTION

Reference will now be made in detail to embodiments of the present invention, some of which are illustrated in the accompanying drawings, wherein like reference numerals refer to like elements throughout. The detailed description which follows presents methods that may be embodied by routines and symbolic representations of operations of data bits within a computer readable medium, associated processors, general purpose personal computers and the like. These descriptions and representations are the means used by those skilled in the art effectively convey the substance of their work to others skilled in the art.

A method is here, and generally, conceived to be a sequence of steps or actions leading to a desired result, and as such, encompasses such terms of art as “routine,” “program,” “objects,” “functions,” “subroutines,” and “procedures.” The methods recited herein may operate on a general purpose computer or other network device selectively activated or reconfigured by a routine stored in the computer and interface with the necessary signal processing capabilities. More to the point, while the following discussion will concentrate on AGILENT branded devices, the methods presented herein are not inherently related to any particular device; rather, various devices may be used to implement the claimed methods. Machines useful for implementation of the described embodiments include those manufactured by such companies as AGILENT TECHNOLOGIES, INC. and HEWLETT PACKARD, as well as other manufacturers of signal and network test and measurement equipment (also referred to a network instruments).

With respect to the software described herein, those of ordinary skill in the art will recognize that there exist a variety of platforms and languages for creating software for performing the methods outlined herein. Embodiments of the present invention can be implemented using any of a number of varieties of JAVA, however, those of ordinary skill in the art also recognize that the choice of the exact platform and language is often dictated by the specifics of the actual system constructed, such that what may work for one type of system may not be efficient on another system. It should also be understood that the methods described herein are not limited to being executed as software on a microprocessor, but can also be implemented in other types of processors. For example, the methods could be implemented with HDL (Hardware Design Language) in an ASIC (application specific integrated circuits).

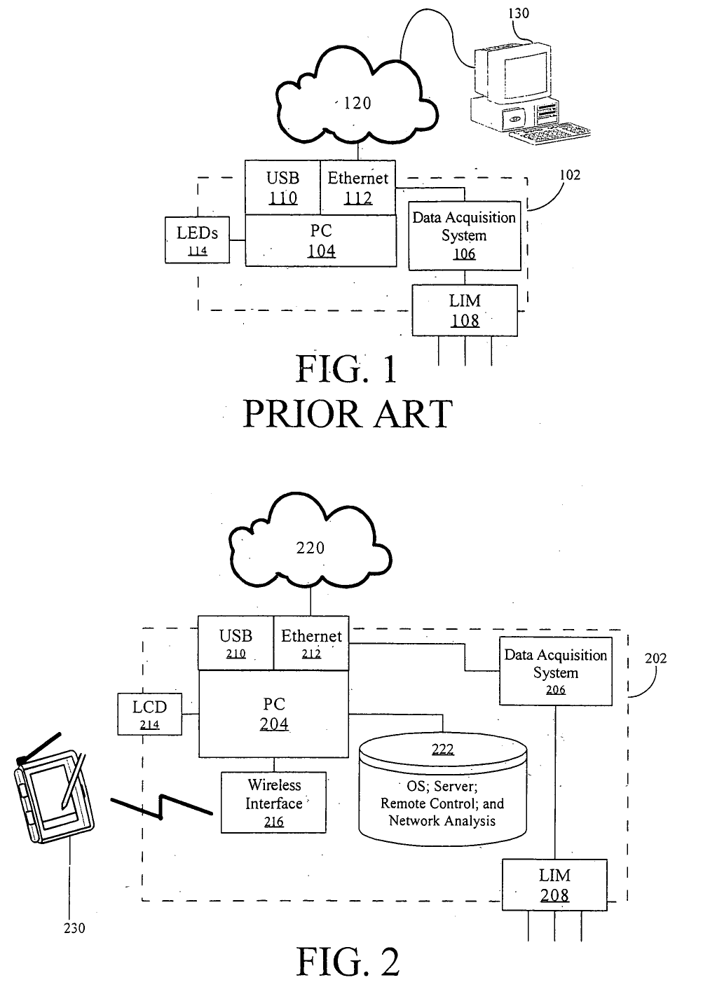

FIG. 1 is a block diagram of a known headless probe 102. The probe 102, generally representative of an AGILENT DNA, comprises a PC 104; a data acquisition system 106 and a line interface module 108 (LIM). The PC 104 is connected to the data acquisition system 106 via an Ethernet interface 112. In turn the data acquisition system 106 is connected to the LIM 108 using a high-speed interface that may be proprietary to the manufacturer of the probe 102. The probe 102 is connected to a central controller via the network 120, which may or may not coincide with the network under test. Additionally, a USB connection 110 and LEDs 114 are provided to facilitate on-site communication including status of the probe 102.

The LIM 108 is an interchangeable module that provides a variety of interface for connecting to a variety of networks, including signaling networks and packet based networks. For example, AGILENT branded LAN LIMs currently exist for: 10baseT & 10/100baseTX; 10/100baseFX; and 1000BaseX (with fiber and copper interfaces), while AGILENT branded cell and frame based WAN LIMs exist for: V-Series; High Speed Serial Interface (HSSI); E1/T1; Eight Port E1/T1 ATM IMA; E3/T3; ATM25; STM-lo/OC-3; and STM-4/0C-12/STM-1/0C-3. LIM 108 provides physical layer and link layer connectivity to the data acquisition system 106 and may also gather physical and link layer statistics. For example, LIMs 108 offer real-time AAL-2 and AAL-5 functionality on thousands of virtual channels simultaneously, and provides ATM and AAL error statistics. LIMs 108 may also have hardware to generate traffic for their associated network technologies.

The data acquisition system 106 is generally dedicated hardware containing a LIM interface along with software and hardware for reassembling frames acquired by the LIM 108 to recreate message streams. In current Agilent systems, the data acquisition system 106 accepts LIMs 108 operating at rates up to 1 Gb/s and performs real-time analysis on traffic for troubleshooting and baselining purposes and to capture traffic at full line rate from both ports of any LIM into a capture memory for protocol analysis by the PC 104.

The PC 104 receives reassembled frames from the data acquisition system 106 along with the outputs of the analysis, troubleshooting and baselining operations. The PC 104 is provided with communication software to communicate the output of the data acquisition system to a central controller 130 (generally comprising a personal computer (PC)) via the network 120. The central controller 130 generally operates in accordance with test and measurement software to perform a variety of test and measurement functions on several types of systems. Examples of such software include AGILENT NETWORK ANALYZER for analyzing network communication and the AGILENT SIGNALING ANALYZER for analyzing signaling communication. Additional information regarding suitable test and measurement software may be found at www.agilent.com.

FIG. 2 is a block diagram of a headless probe in accordance with an embodiment of the present invention. The probe 202 is formed about a core generally comprising: a PC 204; a data acquisition system 206; and a line interface module 208 (LIM). The PC 204 is connected to the data acquisition system 206 via an Ethernet interface 212. In turn the data acquisition system 206 is connected to the LIM 208 using a high-speed interface. The probe 202 is connected to a central controller via the network 220, which may or may not coincide with the network under test. Additionally, a USB connection 210 and an LCD 214 are provided to facilitate on-site communication. The LCD 214 may comprise a small one or two line display. The LIM 208 and data acquisition system 206 are generally in accordance with the LIM 108 and data acquisition system 106.

The PC 204 is connected to a storage system 222 that stores software utilized by the probe 202. In addition to operating system software, the storage system 222 may be provided with test and measurement software, such as the aforementioned NTC, SIGNALING ANALYZER, or NETWORK ANALYZER. The storage system 222 may, for example, comprise a hard disk, flash memory, cd-rom drive, or any suitable memory device. The storage system is also provided with server software and remote control software as discussed herein below.

The PC 104 is additionally connected to a wireless interface 216. The wireless interface may be any of variety of wireless LAN or wireless mobile devices. For example, the wireless interface 216 may comprise an off the shelf PCI-based card in accordance with the Wi-Fi or Wi-Max standards. The wireless interface 216 may also comprise a mobile interface, such as a GSM, GRPS, UMTS, or CDMA2000 compliant interface. Such mobile interfaces are available off the shelf and typically comprise an add-in card based on the PC card standard. By way of additional example, the wireless interface may comprise a Bluetooth compliant module, readily available in a variety of formats, including USB and PC card formats.

While the PC 204 may operate using a variety of operating systems, including any variety of LINUX, or any variety of WINDOWS, the present embodiment will be described using WINDOWS XP EMBEDDED. In accordance with at least one embodiment, the server software comprises an HTML server such a MICROSOFT IIS, APACHE and NETSCAPE ENTERPRISE servers. The server may be enhanced with a variety of software to facilitate function, including the STEELARROW extensions marketed by TOMAHAWK.

The remote control software may generally comprise such readily available products as PC ANYWHERE marketed by SYMANTEC or REMOTE DESKTOP marketed by MICROSOFT. In perhaps a preferred embodiment, the remote control software comprises the ACTIVE-X version of REMOTE DESKTOP, called REMOTE DESKTOP WEB CONNECTION. The Remote Desktop Web Connection is a Win32-based ActiveX control (COM object) that can be used to run Remote Desktop sessions from within Internet Explorer. The downloadable ActiveX control provides most of the same functionality as the full Remote Desktop Connection software in Windows XP, but is designed to deliver such functionality over the Web. Remote Desktop Web Connection facilitates the running of sessions within Internet Explorer or other compatible browser on any Windows 32-bit operating system.

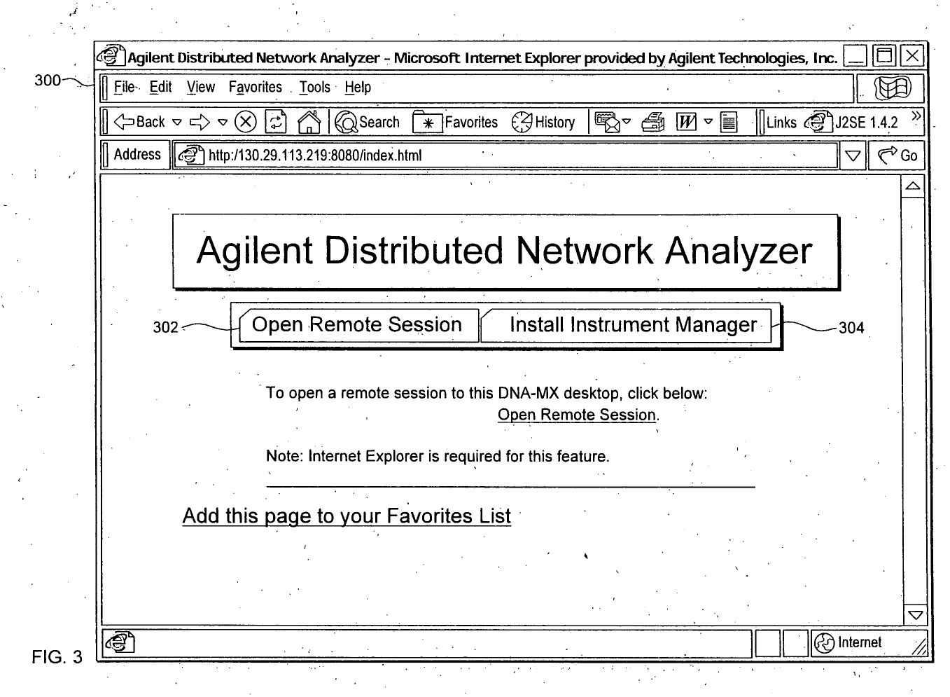

FIG. 3 is a sample of a web page 300 for use with a probe in accordance with an embodiment of the present invention. When users first navigate to a Web page on the server, they are presented with a link 302 to open a remote session. The first time a user clicks on this link, which activates the Remote Desktop Web Connection ActiveX control, they will see a security warning prompting confirmation to install and run the Remote Desktop Web Connection ActiveX control. Once the installation has occurred, the user is presented with an image of the desktop of the operating system on the probe 202. Other options as illustrated by the Install Instrument Manager Link 304 may also be provided, for example running other remote applications, downloading and installing local versions of select software, or accessing other web pages on the server.

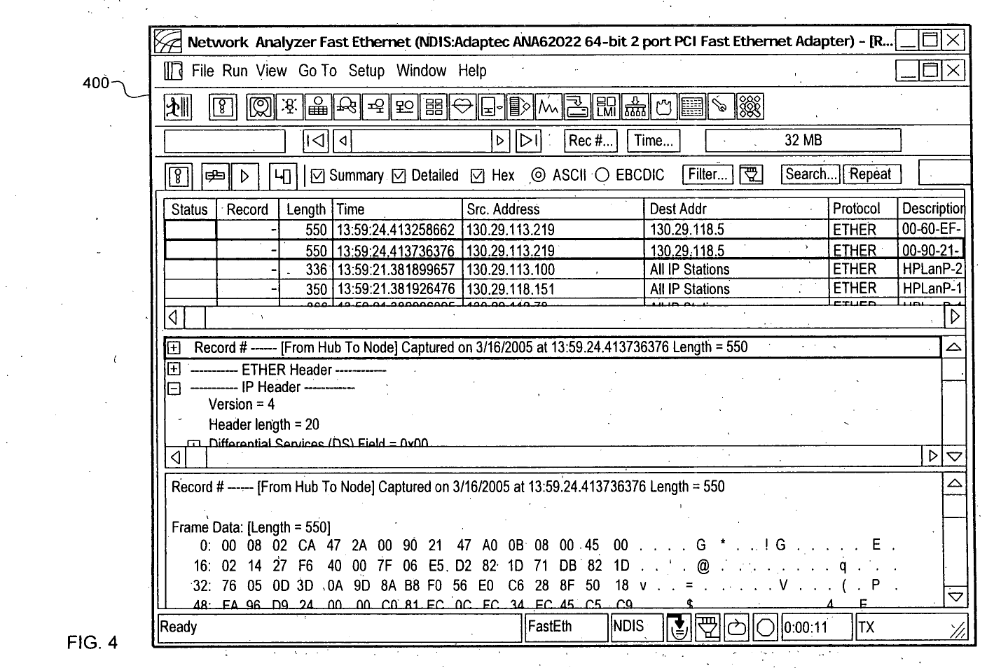

FIG. 4 is a sample screen shot of an window 400 running the Agilent Network Analyzer software, via a Remote Desktop Web Connection ActiveX control, used for interfacing with a probe in accordance with an embodiment of the present invention. The wireless interface 216 coupled with the server software and the remote control software facilitate the connection to and control of the probe 202 to any device 230 equipped with a browser and the appropriate wireless communication hardware. Such a device 230 may comprise a laptop computer, but the device may also comprise a mobile phone or personal data assistant (PDA) equipped with the appropriate communication capabilities. To connect to and control the PC 204, one need only know the Internet address—which may be displayed on the LCD 214.

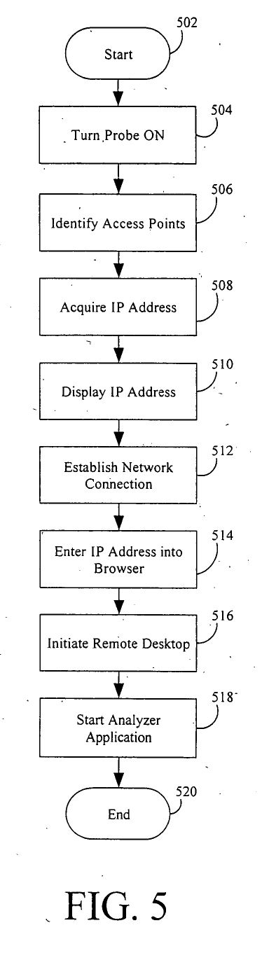

FIG. 5 is a flow chart of a method in accordance with an embodiment of the present invention. The method starts in step 502. In step 504, the probe is turned on. In step 506, the access points for the probe are determined. This generally refers to a process whereby the system determines available communication paths, including which wireless interfaces are available. Next, in step 508, an IP address is acquired, using for example services provided by the operating system. In step 510, the IP address is displayed on, for example, LCD display 214.

In step 512, network connections are established on the wireless device to be used to access the probe. Next in step 514, the IP address displayed in step 510 is entered into a communication program, such as a browser, running on the wireless device. In step 516, a remote desktop session is initiated, for example using Remote Desktop Web Connection. Thereafter in step 518, analyzer applications residing on the probe are initiated under control of the user of the wireless device.

Although an embodiment of the present invention has been shown and described, it will be appreciated by those skilled in the art that changes may be made in these embodiments without departing from the principles and spirit of the invention, the scope of which is defined in the claims and their equivalents.

For example, while the present invention has been described with reference to probes available from Agilent Technologies Inc., the assignee of the present application, the invention is not limited thereto, but is applicable to all test and measurement systems and in particular headless probes and distributed network analyzers.

What is claimed is:

1. A headless test and measurement device comprising:
a core that acquires and analyzes data from a network under test; and
means for wireless communication in communication with the core that sends and receives data to facilitate remote interaction with the core.

2. A headless test and measurement device, as set forth in claim 1, wherein the means for wireless communication utilizes a wireless network standard.

3. A headless test and measurement device, as set forth in claim 1, wherein the means for wireless communication utilizes a mobile communication standard.

4. A headless test and measurement device, as set forth in claim 1, wherein the means for wireless communication utilizes a BLUETOOTH standard.

5. A headless test and measurement device, as set forth in claim 1, wherein the core is provided with remote software facilitating the remote use of the core, the network analyzer further comprising:
a portable computing device in communication with the means for wireless communication and including software for communicating with the remote software on the core to facilitate control of core using the portable computing device.

6. A headless test and measurement device, as set forth in claim 5, wherein the portable computing device comprises a laptop computer.

7. A headless test and measurement device, as set forth in claim 5, wherein the portable computing device comprises a personal data assistant.

8. A headless test and measurement device, as set forth in claim 5, wherein the portable computing device comprises a mobile phone.

9. A network test and measurement system comprising:
a data acquisition system that receives frames from a network under test;
an analyzer executing software analyzing the output of the data acquisition system;
a wireless interface for receiving commands that control the operation of the software.

10. A network test and measurement system, as set forth in claim 9, wherein the analyzer comprises signaling analyzer software.

11. A network test and measurement system, as set forth in claim 9, wherein the analyzer comprises network analyzer software.

12. A network test and measurement system, as set forth in claim 9, wherein the wireless interface utilizes a wireless network standard.

13. A network test and measurement system, as set forth in claim 9, wherein the wireless interface utilizes a mobile communication standard.

14. A network test and measurement system, as set forth in claim 9, wherein the wireless interface utilizes a BLUETOOTH standard.

15. A network test and measurement system, as set forth in claim 9, further comprising:
a portable computing device adapted to communicate with the wireless interface to control the analyzer.

16. A network test and measurement system, as set forth in claim 9, wherein the data acquisition system and the analyzer are in separate housings.

17. A network test and measurement system, as set forth in claim 9, wherein the data acquisition system and the analyzer are in the same housing.

18. A distributed network analysis system comprising:
a headless probe comprising:
a data acquisition system that receives frames from a network under test;
an analyzer executing software analyzing the output of the data acquisition system and outputting results to a remote computing device; and
a wireless interface for receiving commands that control the operation of the software; and
a portable computing device adapted to communicate with the wireless interface to control the analyzer.

19. A method of controlling a headless test and measurement device comprising:
moving a portable computing device into proximity of the headless test and measurement device;
wirelessly connecting the portable computing device to a server on the headless test and measurement device;
replicating the desktop of an operating system installed on the headless test and measurement device on the portable computing device; and
manipulating the replicated operating system on the portable computing device so as to control the headless test and measurement device.
